(19) United States
(12) Patent Application Publication
(10) Pub. No.: US 2007/0005605 A1
(43) Pub. Date: Jan. 4, 2007

(54) System and method for selectively delivering content to a user having one or more accessible devices

(76) Inventor: Arthur D. Hampton, Grayslake, IL (US)

Correspondence Address: MOTOROLA INC, 600 NORTH US HIGHWAY 45, ROOM AS437, LIBERTYVILLE, IL, 60048-5343, US

(21) Appl. No.: 11/172,733

(22) Filed: Jun. 30, 2005

(51) Int. Cl. G06F 17/30

(52) U.S. Cl. 707/10

(57) ABSTRACT

A system and method is provided for delivering content to a user including one or more devices within an area proximate to a user. Each device has one or more output producing elements, and a set of rendering characteristics for each type of content to be delivered to a user via each of the one or more output producing elements. The system selectively activates one or more output producing elements, based upon a comparison of the rendering characteristics of the available output producing elements of the one or more devices within the area proximate to the user for controlling the delivery of content to the user.

### FIELD OF THE INVENTION

The present invention relates generally to delivery of content to a user, and more particularly, to the selective delivery of content to a user having one or more accessible devices.

### BACKGROUND OF THE INVENTION

In recent years, there has been a greater proliferation of personal devices, which have overlapping capabilities, some of which are fixed relative to a particular location, and some of which are carried around with oneself. This is due in part, to the ever increasing capabilities of some devices, where one such example includes a cellular telephone. Some of today's telephones do far more than just place a telephone call. Some of the expanded capabilities include sending and receiving text messages, taking pictures, playing music, accessing the Internet, and/or playing games.

Nevertheless, each device has its strengths and weaknesses, which typically align with a device's primary purpose. Furthermore, there is a general difference regarding capabilities between mobile and fixed devices. While mobile devices may have a degree of additional freedom associated with their portability, which may offer the only opportunity for access when one is out and about, size and power can become a factor which limits a device's capabilities relative to their fixed counterparts. Consequently, there are advantages, which can encourage a user to obtain devices in both forms. As a result, in certain environments, there may be devices having redundant capabilities, especially when one is at home or work where one might be around both fixed and portable devices and/or where different types of devices have functions which overlap. However even when one is at home, it may still be preferable to access content via one's mobile devices, as some fixed appliances or devices may be fixed relative to a particular room, and therefore may not always be the best option.

Still further, depending upon the circumstances, one might use different criteria for judging a preferred rendering device. For example, in some instances, it may be preferable to access content via the available delivery method having the highest quality output. In other instances, one may prefer a delivery method offering the greatest degree of privacy and security.

Additionally, there is an increasing trend toward devices which can share data, such as contact information and appointment information. With the replication of calendar appointments on multiple devices, the possibility increasingly exists that in an effort to insure an appointment reminder is not missed, which may be in the form of an alarm, appointment entries may be synchronized on multiple devices. As a result the receipt of multiple substantially redundant reminders is a real possibility. In some circumstances, redundant reminders can be more of a nuisance than a help.

As a result, the present inventors have recognized, that it would be beneficial to develop a method for selectively delivering content to a user having one or more devices available, which are capable of rendering the content to be delivered. Still further, it would be beneficial to incorporate context awareness into the device, which can be taken into account, when making the decision, as to which devices should be selected for rendering the content for presentation of the information to the user.

### SUMMARY OF THE INVENTION

The present invention provides a method for selectively delivering content to a user having one or more accessible devices. The method includes scanning a proximate area for other devices capable of delivering content to a user including at least a first device and a second device. The rendering characteristics of the devices within the proximate area are then compared. Content for delivery to the user by the one or more devices is then detected and assigned to at least one of the one or more devices, based at least in part upon the comparison of the rendering characteristics of the one or more devices.

In at least one embodiment, comparing the rendering characteristics of the devices within a proximate area includes receiving and comparing one or more of user preference information, user convenience information, and user context information, relative to the type of content to be rendered.

In a still further embodiment, comparing the rendering characteristics of the devices within a proximate area further includes updating the user rendering preferences based upon the received user context information

The present invention further provides a system for delivering content to a user including one or more devices within an area proximate to a user. Each device has one or more output producing elements, and a set of rendering characteristics for each type of content to be delivered to a user via each of the one or more output producing elements. At least one of the one or more devices includes a communication circuit for communicating with one or more other devices within the area proximate to the user. The at least one of the one or more devices further includes a user interface including one or more output producing elements for delivering content to the user, each output producing element having associated rendering characteristics. The at least one of the one or more devices still further includes a control circuit, which is coupled to the communication circuit and the user interface, and includes a comparator and a selector for controlling the selective activation of the one or more output producing elements, based upon a comparison of the rendering characteristics of the available output producing elements of the one or more devices within the area proximate to the user, and for controlling the delivery of content to the user.

These and other objects, features, and advantages of this invention are evident from the following description of one or more preferred embodiments of this invention, with reference to the accompanying drawings.

### BRIEF DESCRIPTION OF THE DRAWINGS

FIG. 1 illustrates a plurality of different contextual environments within which the present invention can be used;

FIG. 2 is a block diagram of a system for delivering content to a user, in accordance with at least one embodiment of the present invention; and

FIG. 3 is a flow diagram of a method for selectively delivering content to a user, in accordance with at least one embodiment of the present invention.

### DETAILED DESCRIPTION OF THE PREFERRED EMBODIMENT(S)

While the present invention is susceptible of embodiment in various forms, there is shown in the drawings and will hereinafter be described presently preferred embodiments with the understanding that the present disclosure is to be considered an exemplification of the invention and is not intended to limit the invention to the specific embodiments illustrated.

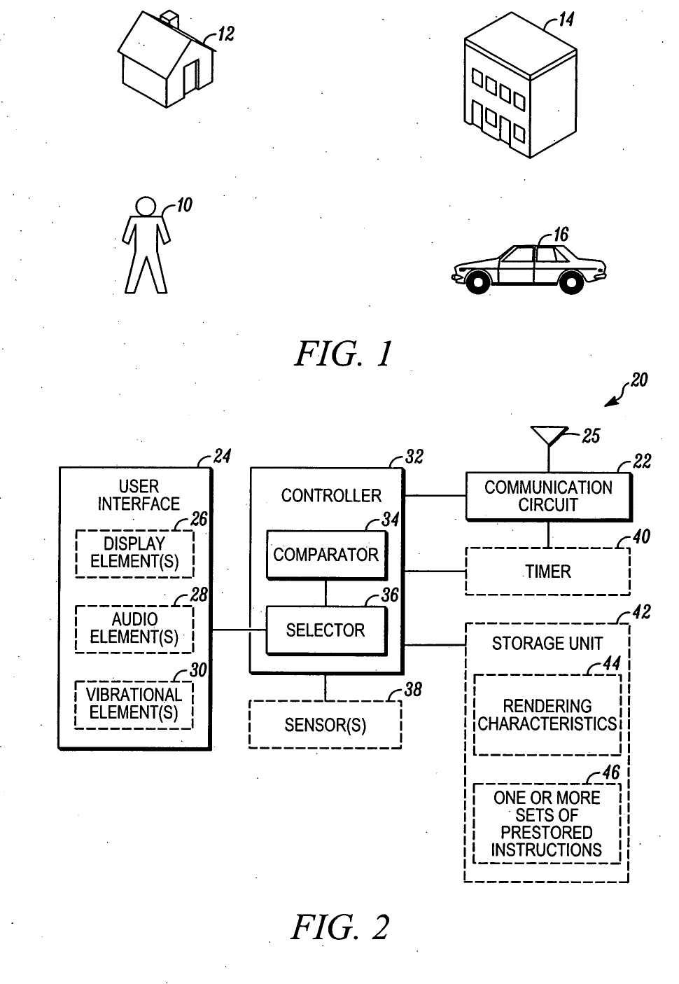

FIG. 1 illustrates a plurality of different contextual environments within which a user 10 may find them self and correspondingly represent examples of different contextual environments within which the present invention can be used. In each instance a user's preference with respect to rendering content can change. Still further, in each environment different devices may be available for performing the actual rendering.

In FIG. 1 at least three different environments are illustrated. The three different environments include at home 12, at work 14, and in the car 16. Many other contextual environment exist and each one can affect the manner in which the user 10 prefers to receive their content. For example, while traveling in an automobile, it may be preferable to receive the audio associated with a telephone call through the car stereo system, which might facilitate a more hands free usage. However, if passengers are present with the user in the automobile, privacy concerns may make a relatively more private form of interaction more prefered. In some instances, the system may be able to detect the presence of passengers using the same sensors, which detect whether a seat belt is being worn. If the system could interact with the corresponding sensors, the additional contextual information may be useful in determining how incoming content should be delivered to the user.

However before a decision can be made as to which device the content should be rendered on, the system needs to know which devices are available for conveying content to the user. In at least some embodiments of the present invention, the system will scan the proximate environment for other system compatible devices, which are available for delivering content to the user. As part of identifying the available devices, the identification of the rendering capabilities associated with each of the devices would be beneficial. In at least some embodiments of the present invention, rendering characteristics might be communicated using a short range wireless communication system, such as Bluetooth. In addition to rendering characteristic, the system might additional collect information, which is available on a particular device, such as entries for appointments in a calendar for which reminders may be desirable.

In determining which devices are available in the proximate area, the devices themselves may provide helpful information for purposes of identifying the environment within which the user 10 is immediately present. Once the capabilities of the devices in the proximate area are known, incoming content to be delivered to the user can be more appropriately assigned to the available devices for conveyance to the user 10. Examples of the types of devices that would be suitable for use with the present invention include cellular telephones, pagers, personal digital assistants (PDAs), watches, car and home stereo systems, televisions (TVs), video cassette recorders (VCRs), digital video disc (DVD) players, personal video recorders (PVRs), answering machines, personal computers, printers, facsimile machines, global positioning system (GPS) receiver, etc. Each one of them would presumably need to be appropriately equipped to interact with the system. Still further, the system would need some form of management device, which could coordinate the available information, and make the necessary decisions for most appropriately routing the content to be delivered to the user.

FIG. 2 illustrates a block diagram of a system 20 for delivering content to a user, in accordance with at least one embodiment of the present invention. The system 20 includes a communication circuit 22 for communicating with the one or more other devices within the area proximate to the user. The communication system is coupled to an antenna 25 for facilitating the transmission and receipt of radio frequency signals. However one skilled in the art will readily recognize that other forms of communication including other forms of wireless communication would be possible without departing from the teachings of the present invention. At least a couple of additional examples of potentially suitable forms of wireless communications include the use of infra-red signals, microwave signals, and laser communications.

With radio waves, one can at least partially control the size of the proximate area, which is scanned, by adjusting the power of the signal used to poll the devices. Several industry standard forms of communication would be similarly suitable including Bluetooth and WLAN 802.11.

The system additionally includes a user interface 24 including one or more output producing elements for the delivery of content to the user 10. Examples of different types of output producing elements include display elements 26, audio elements 28, and vibrational elements 30. The various output producing elements could be directly associated with a system management device, or they can be associated with other devices which have been identified within the proximate area of the user 10.

The system further includes a controller circuit 32 communicatively coupled to the communication circuit and the user interface. The controller circuit 32 includes a comparator 34 which is capable of evaluating the different rendering characteristics, and a selector 36 for controlling the selective activation of the one or more output producing elements. The system can additionally optionally include one or more sensors 38 and a timer 40, where the sensors can provide contextual information which can be used in selecting the most suitable output producing element, and the timer 40 can be used to track elapsed time in conjunction with tracking the current time relative to various scheduled events.

While a sensor associated with detecting the presence of a passenger within an automobile is noted above, further types of sensors are additionally possible including using the microphone on a cellular telephone to detect the amount of noise in the nearby environment, which may effect the selection of an audio producing element for use in playing back an audio signal. It may also suggest that a vibratory alert in place of an auditory alert may alternatively be more effective. The noise in the nearby environment could also produce clues as to the area in which the user is presently located.

In managing the alerts associated with scheduled events an aggregate list of events can be compiled and duplicates can be filtered at the time a reminder alert is to be presented to a user in order to avoid redundant alerts. Still further at approximately the same time, the most appropriate output device for providing the alert can be selected.

The system could additionally include a storage unit 42, which might be used in storing rendering characteristic 44, and/or one or more sets of prestored instructions 46. In some instances, the one or more sets of prestored instructions can represent executable code for execution by one or more microprocessors, which might make up all or parts of the controller 32 and facilitate the proper functioning of the same. Alternatively, any prestored instructions could be included as part of the controller 32. The prestored instructions 46 could take the form of firmware, microcode, and/or a file containing a list of executable instructions.

The rendering characteristics 44, in addition to including some of the capabilities of some of the output producing elements, such as display size and color depth, such as for a display element, the rendering characteristics can alternatively and/or additionally include user preference information, user convenience information and user context information relative to the various types of content to be rendered.

Contextual information can be helpful, because there may be a bias against delivering content on a device which is not presently activated, or alternatively might already be delivering other content to the user. In some instances bigger may not always be better. For example, a higher resolution monitor might be a poor choice for displaying a picture containing a relatively few number of pixels, as the resulting image may be very small and difficult to see. Furthermore, some devices might be better suited to delivering black and white content, where other devices may be better suited to presenting color content. Consequently, the nature of the content to be delivered may sometimes affect the more optimum choice relative to the selection of an output producing element for rendering the content.

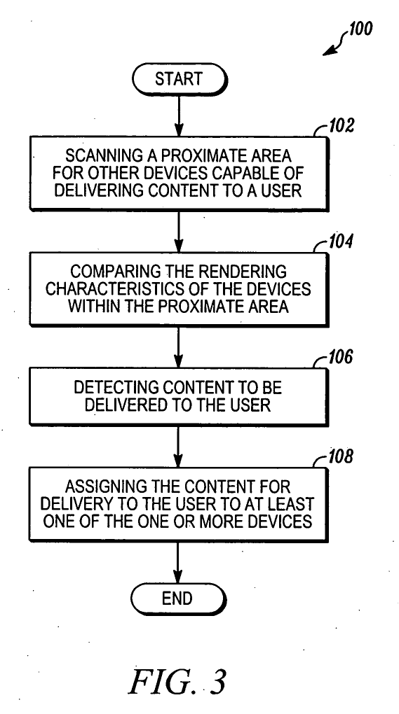

FIG. 3 illustrates a flow diagram of a method 100 for selectively delivering content to a user having one or more accessible devices, in accordance with at least one embodiment of the present invention. The method includes scanning 102 a proximate area for other devices capable of delivering content to a user including at least a first device and a second device. The rendering characteristics of the devices within the proximate area are then compared 104. Content to be delivered to the user by the one or more devices is then detected 106, and then the content for delivery to the user is assigned 108 to at least one of the one or more devices, based at least in part upon the comparison of the rendering characteristics of the one or more devices.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method for selectively delivering content to a user having one or more accessible devices, the method comprising:
scanning a proximate area for other devices capable of delivering content to a user including at least a first device and a second device;
comparing the rendering characteristics of the devices within the proximate area;
detecting content to be delivered to the user by the one or more devices; and
assigning the content for delivery to the user to at least one of the one or more devices, based at least in part upon the comparison of the rendering characteristics of the one or more devices.

2. A method in accordance with claim 1 wherein at least some of the content to be delivered to the user is conveyed to the user as part of one or more scheduled events.

3. A method in accordance with claim 2 wherein the one or more scheduled events include one or more programmed alarms.

4. A method in accordance with claim 2 wherein assigning the content to be delivered to the at least one of the one or more devices includes detecting and eliminating any redundant scheduled events.

5. A method in accordance with claim 2 further comprising receiving user input relative to a scheduled event via a user input device and forwarding the information to the one or more user devices, which are associated with the corresponding scheduled event.

6. A method in accordance with claim 1 wherein comparing the rendering characteristics of the devices within a proximate area includes receiving and comparing one or more of user preference information, user convenience information, and user context information, relative to the type of content to be rendered.

7. A method in accordance with claim 6 wherein receiving user context information includes receiving user context information from supplemental information sources.

8. A method in accordance with claim 7 wherein supplemental information sources includes one or more nearby sources, user supplied information, and information based upon proximity to another device.

9. A method in accordance with claim 6 wherein comparing the rendering characteristics of the devices within a proximate area further includes updating the user rendering preferences based upon the received user context information.

10. A method in accordance with claim 9 wherein updating the user rendering preferences includes selectively weighting the user rendering preferences.

11. A method in accordance with claim 1 further comprising after scanning the proximate area for other devices capable of delivering content to a user, creating a composite list of events to be performed by the one or more devices, wherein content is delivered to a user.

12. A system for delivering content to a user comprising one or more devices within an area proximate to a user, each device having one or more output producing elements, and a set of rendering characteristics for each type of content to be delivered to a user via each of the one or more output producing elements, at least one of the one or more devices including:
a communication circuit for communicating with one or more other devices within the area proximate to the user;
a user interface including one or more output producing elements for delivering content to the user, each output producing element having associated rendering characteristics;
a control circuit, coupled to the communication circuit and the user interface, including a comparator and a selector for controlling the selective activation of the one or more output producing elements, based upon a comparison of the rendering characteristics of the available output producing elements of the one or more devices within the area proximate to the user, and for controlling the delivery of content to the user.

13. A system for delivering content to a user in accordance with claim 12 wherein each of the one or more output producing elements delivers content to be received by one or more senses of the user.

14. A system for delivering content to a user in accordance with claim 13 wherein the content to be delivered to the user is associated with one or more senses of the user, and wherein the associated senses of the content to be delivered is matched with the content delivery capabilities of one or more of the output producing elements.

15. A system for delivering content to a user in accordance with claim 12 wherein the at least one of the one or more devices further includes a storage circuit for storing at least one of a list of one or more scheduled events, rendering characteristics of the associated output producing elements, and content to be delivered to the user.

16. A system for delivering content to a user in accordance with claim 12 wherein the at least one of the one or more devices further includes one or more sensors, coupled to the control circuit, for detecting user context information.

17. A system for delivering content to a user in accordance with claim 12 wherein the at least one of the one or more devices further includes a timer, coupled to the control circuit, having a value representative of elapsed time; and wherein the content to be delivered to the user includes one or more scheduled events, which defines content to be delivered to the user based upon the value of the timer.

18. A system for delivering content to a user in accordance with claim 12 wherein the at least one of the one or more devices includes one or more input elements for receiving information from the user in association with content to be delivered to the user, and wherein the input received from the user is forwarded to the device, which is the originator of the corresponding delivered content.

19. A system for delivering content to a user in accordance with claim 12 wherein the output producing element includes at least one of one or more display elements, one or more audio elements, and one or more vibrational elements.
